(19) United States
(12) Patent Application Publication
(10) Pub. No.: US 2023/0256994 A1
(43) Pub. Date: Aug. 17, 2023

(54) ASSESSING RELATIVE AUTONOMOUS VEHICLE PERFORMANCE VIA EVALUATION OF OTHER ROAD USERS

(71) Applicant: GM CRUISE HOLDINGS LLC, SAN FRANCISCO, CA (US)

(72) Inventors: Katherine Mary Stumpf, San Francisco, CA (US); Tal Green, Berekely, CA (US); Miles Avery Bowman, San Mateo, CA (US)

(73) Assignee: GM CRUISE HOLDINGS LLC, SAN FRANCISCO, CA (US)

(21) Appl. No.: 17/673,035

(22) Filed: Feb. 16, 2022

(51) Int. Cl. B60W 60/00; G07C 5/08; G07C 5/02; B60W 50/00

(52) U.S. Cl. CPC B60W 60/0015; G07C 5/0808; G07C 5/02; B60W 50/0098; B60W 2050/0088

(57) ABSTRACT

Architectures and techniques for assessing relative vehicle performance utilizing data gathered by monitoring other vehicles are disclosed. Operational information is gathered for a host platform and for at least one other platform that shares an operating environment with the host platform. Multiple evaluations are performed on the operational information for the host platform and on the operational information for at least one other platform. Host platform performance is evaluated based on results from the evaluations on the operational information from the host platform and on results from the operational information from at least one other platform. One or more operational parameters corresponding to the host platform are adjusted based on the evaluation.

### TECHNICAL FIELD

Examples provided herein relate to monitoring and evaluating road users (e.g., vehicles, cyclists, pedestrians, pets). More particularly, examples provided herein related to assessment of a host autonomous vehicle (AV) based on information gathered through monitoring other road users.

### BACKGROUND

An autonomous vehicle (AV) is a vehicle that can operate itself by performing necessary control operations without human interaction through use of an automated driving system. AVs have the ability to monitor its surroundings through use of various sensors and respond to external conditions in a manner to allow the AV to navigate a selected route.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an example autonomous vehicle.

FIG. 2 illustrates an aspect of the subject matter in accordance with one embodiment.

FIG. 3 is a flow diagram for one technique for assessing relative vehicle performance utilizing data gathered by monitoring other vehicles.

FIG. 4 is a block diagram of one example of a processing system that can provide assessment of relative vehicle performance utilizing data gathered by monitoring other vehicles.

### DETAILED DESCRIPTION

Development of autonomous vehicles (AVs) including, for example, development of control systems, sensor systems and other components is an expensive and time consuming process that involves gathering large amounts of data, analyzing the data and evaluating results. Other related issues, for example, include areas and/or times during which the AVs are allowed to operate. These and other issues can be influenced by the development process and data that comes from the development process. Thus, improved gathering and utilization of data can result in an improved development process.

The techniques and mechanisms described herein can provide a dynamic, relatively real-time assessment of driving and road conditions for an AV as a byproduct of AV operation (e.g., as part of a rideshare service, as part of a delivery service, other types of fleet operations whether commercial or non-commercial). Data corresponding to these assessments can be utilized to generate risk/safety ratings, evaluate AV performance relative to other drivers, generate models or evaluations for reactivity of other vehicles, etc. As other examples, comfort ratings can be utilized and dynamic changes/conditions can be responded to in ways that would otherwise not be possible because of a lack of additional information about how vehicles operate in the specific environment.

In the examples that follow, various areas of autonomous vehicle (AV) operation can be upgraded. By utilizing the assessment data, risks associated with driving in or through a specific traffic/road feature (e.g., a specific intersection) can be more accurately evaluated by including the behavior of other vehicles using the traffic/road feature. As another example, evaluating whether an AV's performance is sufficient to expand the AV's operational design domain (ODD) and/or help determine what additions/changes to the ODD are appropriate, and determine whether any aspect of the AV's driving (e.g., left turns) lags behind other vehicles in the same areas (e.g., non-AVs or other AVs maneuvering the same traffic features). The assessment data can also be utilized to generate simulations of the reactivity of other (e.g., human-operated or non human-operated) vehicles for testing AVs in a simulated environment (e.g., generating non-player characters (NPCs) in a simulated environment in which a simulated AV, which uses part or all of the software stack of an AV used in the real world, is operating).

In general, the ODD specifies operating conditions under which the subject AV is allowed to operate. The ODD may be defined in terms of environmental restrictions, geographical restrictions, time of day restrictions, presence or absence of certain other characteristics and/or other features. The ODD can be used to limit when and where the AV can operate so that the AV operates in conditions for which it has been designed and tested.

By leveraging various types of data (e.g., safety and comfort data) utilized by the host AV along with data gathered by one or more AVs during operation, more and potentially better, data-driven decisions can be made. In one example, AVs can collect data on other vehicles (e.g., vehicle type, maneuvers performed, location, time) that are operated by humans in the vicinity of the AV. The collected data can be utilized to, for example, compare AV performance to human-operated vehicle performance. This evaluation can be utilized to determine if the AV is performing at expected levels. For example, some cities or areas have different conventions (e.g., a Boston Left Turn—where the first car in a left turn lane makes the left turn immediately after the light changes to green and the oncoming drivers understand and allow the turn) where an AV may not adapt to local conventions without custom programming. Use of the approaches described herein can allow the AV to adapt to these local conventions without the need for custom programming by witnessing the operation of one or more human-operated vehicles and adapting default behaviors to be more consistent with the human-operated vehicles. Other advantages can also be provided, for example, ODD management, areas to avoid and/or risk-aware routing. As another example, the reactivity of other vehicles can vary over time (e.g., rush hour vs. late night), the awareness of which can improve the overall performance of the AV.

Although variously described herein as an AV or another device collecting data of surrounding vehicles, this data may be collected without associated identifiable information from these surrounding vehicles (e.g., without license plate numbers, make, model, and color of the vehicles). Accordingly, the techniques mentioned herein can be used for the beneficial purposes described throughout but without the need to store potentially sensitive information of surrounding vehicles.

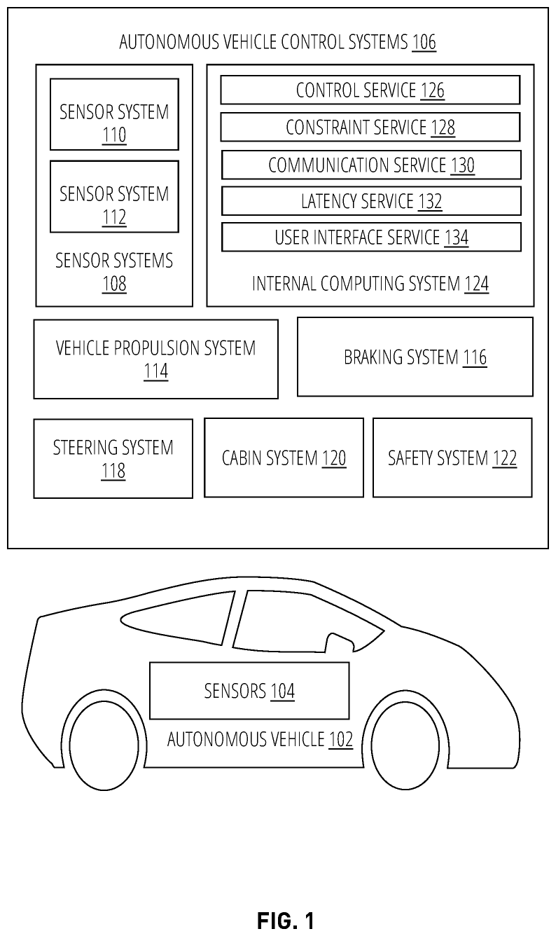

FIG. 1 is a block diagram of an example autonomous vehicle. Autonomous vehicle 102 has the functionality to navigate roads without a human driver by utilizing sensors 104 and autonomous vehicle control systems 106. Autonomous vehicle 102 can operate within a fleet of multiple AVs (not illustrated in FIG. 1). In a fleet setting, each AV can share information with other AVs in the fleet and/or with a centralized control architecture. In various examples that follow, multiple AVs (e.g., autonomous vehicle 102) in a fleet can gather data corresponding to the respective AVs and corresponding to other vehicles (whether human-operated or other AVs) that the AV experiences/encounters. AV models (e.g., comfort, safety) can be applied to the data gathered from the other vehicles to assess the driving of the other vehicles. This information can be utilized for various purposes including, for example, determining AV relative performance with respect to other vehicles (including human-controlled vehicles), determining risk profiles for various traffic features, improving reactivity for particular environments, etc.

Autonomous vehicle 102 can include, for example, sensor systems 108 including any number of sensor systems (e.g., sensor system 110 and sensor system 112). Sensor systems 108 can include various types of sensors that can be arranged throughout autonomous vehicle 102. For example, sensor system 110 can be a camera sensor system. As another example, sensor system 112 can be a light detection and ranging (LIDAR) sensor system. As a further example, one of sensor systems 108 can be a radio detection and ranging (RADAR) sensor system, an electromagnetic detection and ranging (EmDAR) sensor system, a sound navigation and ranging (SONAR) sensor system, a sound detection and ranging (SODAR) sensor system, a global navigation satellite system (GNSS) receiver system, a global positioning system (GPS) receiver system, accelerometers, gyroscopes, inertial measurement unit (IMU) systems, infrared sensor systems, laser rangefinder systems, microphones, etc.

As autonomous vehicle 102 operates (whether autonomously or in another mode), sensors 104 can be utilized to gather kinematic data about other vehicles on the road as well as the behavior of autonomous vehicle 102. The collected data can be filtered, for example, to vehicles semantically similar to autonomous vehicle 102, or to an AV in the fleet. In some examples, vehicles that are not similar to autonomous vehicle 102 can be excluded from evaluation. In other examples, vehicles that are not similar to autonomous vehicle 102 can be evaluated differently (e.g., using weights) or not evaluated.

In another example, data can be further filtered by time of day, location and/or maneuver type (e.g., morning rush hour at 1st Avenue and 1st Street while making an unprotected left turn). Further examples can include seasons, scheduled events (e.g., football game, concert, parade, rally, convention), etc. Additional and/or different data sets and filtering schemes can also be supported. In one example, information is gathered by sensors 104 when autonomous vehicle 102 is operating as an autonomous rideshare vehicle. Data can be gathered in other modes of operation as well, including autonomous delivery and non-commercial autonomous driving.

Autonomous vehicle 102 can further include mechanical systems to control and manage motion of autonomous vehicle 102. For example, the mechanical systems can include vehicle propulsion system 114, braking system 116, steering system 118, cabin system 120 and safety system 122. Vehicle propulsion system 114 can include, for example, an electric motor, an internal combustion engine, or both. Braking system 116 can include an engine brake, brake pads, actuators and/or other components to control deceleration of autonomous vehicle 102. Steering system 118 can include components that control the direction of autonomous vehicle 102. Cabin system 120 can include, for example, cabin temperature control systems, in-cabin infotainment systems and other internal elements.

Safety system 122 can include various lights, signal indicators, airbags and/or systems that detect and react to other vehicles. Safety system 122 can include one or more radar systems. Autonomous vehicle 102 can utilize different types of radar systems, for example, long-range radar (LRR), mid-range radar (MRR) and/or short-range radar (SRR). LRR systems can be used, for example, to detect objects that are farther away (e.g., 200 meters, 300 meters) from the vehicle transmitting the signal. LRR systems can operate in the 77 GHz band (e.g., 76-81 GHz). SRR systems can be used, for example, for blind spot detection or collision avoidance. SRR systems can operate in the 24 GHz band. MRR systems can operate in either the 24 GHz band or the 77 GHz band. Other frequency bands can also be supported.

Autonomous vehicle 102 can further include internal computing system 124 that can interact with sensor systems 108 as well as the mechanical systems (e.g., vehicle propulsion system 114, braking system 116, steering system 118, cabin system 120 and safety system 122). Internal computing system 124 includes at least one processor and at least one memory system that can store executable instructions to be executed by the processor. Internal computing system 124 can include any number of computing sub-systems that can function to control autonomous vehicle 102. Internal computing system 124 can receive inputs from passengers and/or human drivers within autonomous vehicle 102.

Internal computing system 124 can include control service 126, which functions to control operation of autonomous vehicle 102 via, for example, the mechanical systems as well as interacting with sensor systems 108. Control service 126 can interact with other systems (e.g., constraint service 128, communication service 130, latency service 132 and internal computing system 124) to control operation of autonomous vehicle 102.

Internal computing system 124 can also include constraint service 128, which functions to control operation of autonomous vehicle 102 through application of rule-based restrictions or other constraints on operation of autonomous vehicle 102. Constraint service 128 can interact with other systems (e.g., control service 126, communication service 130, latency service 132, user interface service 134) to control operation of autonomous vehicle 102.

Internal computing system 124 can further include communication service 130, which functions to control transmission of signals from, and receipt of signals by, autonomous vehicle 102. Communication service 130 can interact with safety system 122 to provide the waveform sensing, amplification and repeating functionality described herein. Communication service 130 can interact with other systems (e.g., control service 126, constraint service 128, latency service 132 and user interface service 134) to control operation of autonomous vehicle 102.

Internal computing system 124 can also include latency service 132, which functions to provide and/or utilize timestamp information on communications to help manage and coordinate time-sensitive operations within internal computing system 124 and autonomous vehicle 102. Thus, latency service 132 can interact with other systems (e.g., control service 126, constraint service 128, communication service 130 and user interface service 134) to control operation of autonomous vehicle 102.

Internal computing system 124 can further include user interface service 134, which functions to provide information to, and receive inputs from, human passengers within autonomous vehicle 102. This can include, for example, receiving a desired destination for one or more passengers and providing status and timing information with respect to arrival at the desired destination. User interface service 134 can interact with other systems (e.g., control service 126, constraint service 128, communication service 130 and latency service 132) to control operation of autonomous vehicle 102.

Internal computing system 124 can function to send and receive signals from autonomous vehicle 102 regarding reporting data for training and evaluating machine learning algorithms, requesting assistance from a remote computing system or a human operator, software updates, rideshare information (e.g., pickup and/or dropoff requests and/or locations), etc.

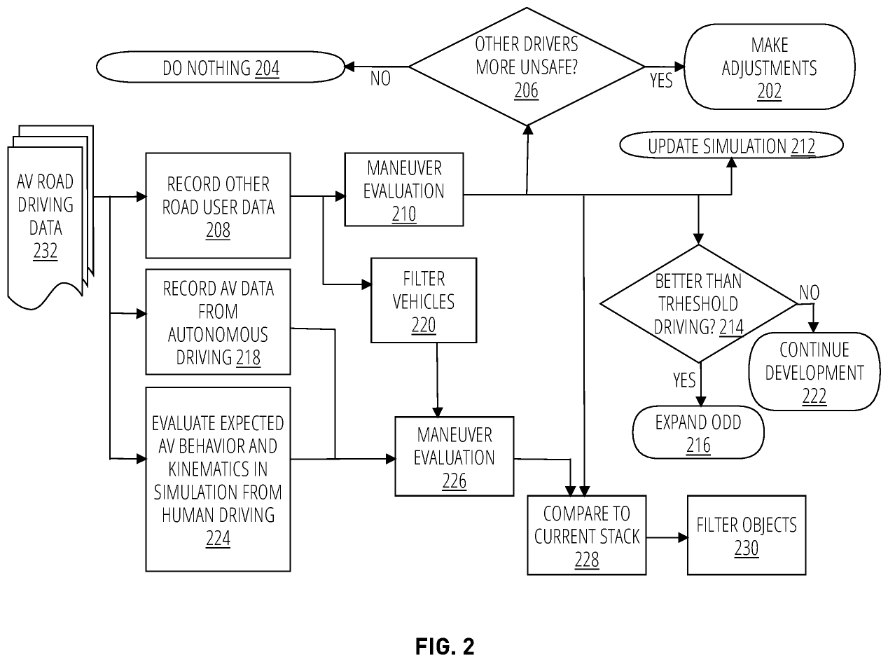

FIG. 2 is a flow diagram of one example use case for assessing relative vehicle performance utilizing data gathered by monitoring other vehicles. The example use cases of FIG. 2 provide a subset of examples of the type of analysis and system management that can be accomplished utilizing data gathered from one or more AVs regarding their own behavior and the behavior of other vehicles in the operating environment. In some examples, data collected on other road users can be translated into models that can be used to determine how the AV would have performed in those scenarios.

As used in the flow diagram of FIG. 2, AV road driving data 232 can be operational data acquired, for example, by sensors 104 of autonomous vehicle 102, which can be one of many AVs in a fleet of AVs. AV road driving data 232 is generally data captured from previous road trips by the host AV and/or other AVs in the fleet. AV road driving data 232 can also include simulation data that is generated based on the acquired data, based on other data sets or a combination thereof. In an example, as the AV (e.g., autonomous vehicle 102) operates within its designated ODD, various pieces of sensor information can be gathered and stored as AV road driving data 232 including, for example, speed, location, steering inputs, throttle inputs, RADAR and/or LIDAR point cloud information, etc. For example, AV road driving data 232 can include, as the AV executes a right turn at a busy intersection, speed data, steering angle data, distance to obstacles (e.g., pedestrians, curbs, other vehicles), geographic location, time of day, etc.

During operation, the AV can capture observational data corresponding to other road users. Other road users can include, for example, other vehicles on the road (whether AV or human operated), motorcycles, bicycles, pedestrians, etc. The various sensors of the host AV (e.g., sensors 104 in autonomous vehicle 102) can capture data such as speed of other vehicles, acceleration and/or deceleration of other vehicles, following distances, etc.

Thus, AV road driving data 232 can include operational data for the host vehicle for autonomous driving 218 and observational data for other road users 208. In an example, kinematics and/or behavior information and/or decisions for other road users 208 can be extracted/recorded from AV road driving data 232. Similarly, kinematics and behavior decisions for the host AV 218 corresponding to data captured during autonomous driving can be extracted/recorded from AV road driving data 232. Further, expected AV kinematics and behavior decisions 224 can be extracted (or extrapolated) from AV road driving data 232. Thus, AV road driving data 232 can include data captured from one or more AVs as well as data generated by a simulation. The simulation data can be based on data captured by one or more AVs and/or test data that has not been captured by AVs.

In one example, kinematics and/or behavior information for other road users 208, can be filtered based on, for example, vehicle type, 220 (e.g., filtering out vehicles that are dissimilar from the host AV or another designated baseline vehicle). Other parameters can be used for filtering in other examples. The filtered data from other road users can be evaluated (e.g., used in a simulation) to determine how the AV would have behaved in the same situation, 226. In one example, each maneuver performed by another vehicle is evaluated using a collection of test suites used to score the behavior of the AV for safety and comfort 326. These scoring models can be correlated with on-road events and have a variety of feature inputs. These features can be calculated based on collected data and generally correspond to interactions between a vehicle of interest, other road actors and specific surroundings. Additional and/or different evaluations 226 can also be performed.

The same (or similar) test suites for (e.g., for AV safety and comfort) maneuver evaluation, 226, can also be applied to kinematic and behavior data from autonomous driving, 218 and to expected AV kinematics and behavior data from simulation(s) 224. Maneuver evaluation 210 can also be performed on kinematics and behavior data for other road users (e.g., unfiltered) 208.

An evaluation can be performed to determine if the other road users are more unsafe than expected guidelines 206. In one example, safety evaluation can include various factors, for example, time of day, day of the week, season, location, weather, maneuver type, whether it is a holiday, whether any special events are occurring, etc. If the other road users are not more unsafe, 206, then no modifications with respect to routing are performed, 204. If the other road users are more unsafe, 206, then adjustments can be made 202 (e.g., avoidance areas can be introduced and/or routing cost at the corresponding location can be increased). These actions can function to decrease the likelihood that the AV will drive in the an area considered unsafe (or less safe than a human-operated vehicle). In one example, simulation behavior of non-AV road users can be updated, 212, based on results of one or more maneuver evaluations 210.

Data and results from maneuver evaluations 210 and 226 can be utilized to update and improve simulations and/or can be added to AV road driving data 232 for subsequent iterations of the operations described in FIG. 2. Further, data and results from maneuver evaluations 210 and 226 can be provided to other entities. For example, this information can be provided to a city in which the AV fleet operates to make adjustments to the traffic infrastructure of the city.

The maneuver evaluations (e.g., 210 and 226) can provide information indicating, for example, where an AV lags in performance as compared to other road users. The maneuver evaluations can further provide insight into what conditions or processes have resulted in performance below expectations. As a result, various actions can be taken to address any deficiencies identified. For example, the AV can be configured to avoid certain areas and/or situations (e.g., avoid particular maneuvers in a designated area). As another example, additional developmental resources can be dedicated to addressing the situation. Thus, both safety and development resource allocation can be improved in ways that may not be otherwise possible by performing evaluations with data sets that would otherwise not be available.

In an example, maneuver evaluation data for other road users 210 and maneuver evaluation data for the host AV 226 are compared to current AV stack performance 228. With these results, it can be determined if the AV is driving better than a threshold level of other road users (e.g., better than 75%, better than 83% and/or better than 95% of other road users) 214. If AV driving performance exceeds the threshold, 214, the AV's ODD can be expanded 216. The ranking can be based on various factors, for example, time of day, day of the week, season, location, weather, maneuver type, whether it is a holiday, whether any special events are occurring, etc.

Thus, the AV's ODD can be expanded 216 if it drives better than a threshold percentage/number of all road users in a specific area 214 (e.g., in an area outside the current ODD). Also, the reactivity of non-automated vehicles in simulations can be tuned based on the specific ODD dynamically to reflect real time changes in road conditions. If the AV driving does not exceed the threshold, 214, development can be continued 222 (e.g., development priorities of the AV stack can be ranked and/or reprioritized using maneuver evaluation results 210 and 226 with the aim of AV performance satisfying the threshold).

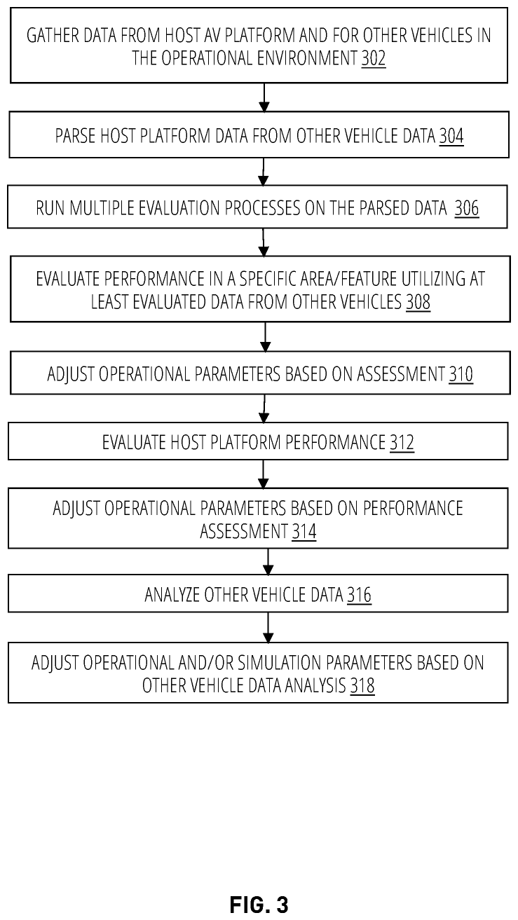

FIG. 3 is a flow diagram for one technique for assessing relative vehicle performance utilizing data gathered by monitoring other vehicles. The approach described herein can function to provide a relatively real time assessment of road features as a byproduct of operating one or more AVs (e.g., AV rideshare fleet, AV delivery fleet, AV development fleet). Further, ongoing assessment of AV performance relative to other drivers of similar vehicles in specific ODDs and/or specific traffic features can provide improved evaluation as compared to training by human drivers or universal metrics. Relative performance can also be utilized to identify and prioritize improvements in autonomous driving. Ongoing assessments can also improve simulation fidelity of other driver behavior in specific domains to provide a relatively real time model of other vehicles.

In block 302, operational data is gathered from the host platform (e.g., autonomous vehicle 102 with sensors 104) for the host platform and observational data is gathered for other vehicles in the operational environment. In one example, the host platform is an AV that is providing rideshare functionality; however, the host platform can be an AV that is not providing a rideshare functionality, such as an AV delivery vehicle, a human-operated vehicle with an advanced driver assistance system (ADAS), etc. Information gathered can be for the host AV platform (e.g., location, speed, acceleration rate, steering angle, proximity to other road users, whether headlights are on). Information can also be gathered for other road users (e.g., speed of other vehicles, following distance of other vehicles, turn signal status). General geographical and/or environmental information can also be gathered (e.g., location, time of day, weather conditions).

The data collection approaches described herein provides near real time updates (as described above) and can possibly capture near misses and other incidents too minor to report by the participants. Thus, the approach described herein provides a more thorough and complete collection of data, which can result in improved development and functionality.

In block 304 data gathered by the host AV platform can be parsed, for example, operational data corresponding to the host AV platform can be separated from observational data corresponding to other road users (e.g., other vehicles). As mentioned above, the host platform data and/or the other vehicle data can be run through one or more simulations to provide additional data, for example, evaluation with respect to safety of specific operations, evaluation of relative performance of specific operations. Parsing of the data provides multiple data sets that can be utilized for various comparison purposes to provide advantageous analysis, for example, automated ODD management, AV profile management, etc. For example, the autonomous operations of the host AV can be compared to similarly sized and/or similarly situated human-operated vehicles to determine if the AV is operating within expected characteristic ranges.

In block 306 multiple evaluations are performed on the parsed data sets. For example, safety, comfort and/or performance evaluations can be performed on the observational data corresponding to other vehicles. (e.g., 210). Similarly, safety, comfort and/or performance evaluations can be performed on the host platform operational data (e.g., 226) and safety, comfort and/or performance evaluations can be performed on simulation data (e.g., 226). Additional and/or different data set combinations can be generated and additional and/or different evaluations can be performed.

In the example of FIG. 3, operations are illustrated and described in a specific order; however, the illustrated order is just an example and not the only possible order. For example, the operations of block 306, block 308, block 312 and block 314 are illustrated and described as sequential. Alternatively, the operations of block 306 and block 308 can be performed in parallel with the operations of block 312 and block 314. Many other alternative orderings can also be supported.

In block 308 performance associated with driving in or through a specific traffic feature can be evaluated based on at least the other vehicles using the specific traffic feature. The risk analysis can further utilize operational data from the host platform. In one example, evaluations of observational data from the other vehicles and evaluations of operational data from the host platform can be compared as part of the risk evaluation. Specific traffic features can include, for example, specific intersections, specific sections of a road, construction zones, etc. Any number of characteristics can be utilized to provide specificity to the traffic feature including, for example, time of day, day of the week, season, weather conditions, lighting.

As one specific example, as a result of the multiple evaluations, the performance of the host AV for a specific set of one or more operations (e.g., a right turn from Market Street to Spear Street in San Francisco during a morning commute period) can be compared to other road users performing the same operations. As another example, actions of other road users can be evaluated to determine whether the host AV is operating safely and/or within expected local customs. For example, sudden movements of other road users away from the AV can indicate unexpected movements by the AV.

In block 310 operational parameters of the AV can be adjusted based on the assessments (block 308). Adjustment of the operational parameters can include, for example, modification of an AV ODD, modification of routing preferences, limitations on times during which the host platform can access specific traffic features, modification of safety buffers in specified areas, etc. For example, if the performance assessments indicate that the AV does not perform night time left turns at a specific intersection better than 75% of human drivers, for subsequent trips the AV may be rerouted to avoid that intersection at night until further performance improvements and/or development processes can be implemented.

In block 312 performance evaluations are performed utilizing host platform data and/or other vehicle data. The performance evaluations can be used to, for example, compare AV performance to desired performance levels, compare AV performance to historical AV performance trends, compare AV performance to human-operated vehicles, compare specific AV performance to other AVs in the fleet, etc. Additional and/or different performance evaluations can be supported.

The evaluation of block 312 can be more general than the evaluation of block 308. For example, while the evaluation of block 308 is focused on a set of one or more operations (e.g., performance at a specific intersection, night 4-way stops, yielding to bicycles), the evaluation of block 312 is directed to overall performance of the host AV as compared to other vehicles. The evaluation of block 312 can be for general operation in an ODD or for a subset (e.g., daytime operation within a subset of the ODD) as compared to other vehicles in the same areas. These evaluations can be used, for example, to determine whether the AV is operating well enough to extend the AV operational parameters (e.g., allow operation at dusk, add streets to ODD).

In block 314 operational parameters can be adjusted based on the performance evaluations. For example, a specific vehicle ODD can be modified based on the performance evaluations and/or an AV fleet ODD can be modified based on individual and/or aggregated performance evaluations. Performance evaluations can also be used to determine areas in which one or more AVs are deficient in performance. This can be based on training of a single AV and/or fleet development. Additional and/or different evaluations and corresponding adjustments can also be supported.

In block 316 data gathered about other vehicles can be analyzed. In one example, analysis of other vehicle data can be used for comparison purposes to evaluate how well the host AV fits in traffic flows with human-operated vehicles. Results of these comparisons can be utilized to adjust operational parameters for the AV. As another example, analysis of other vehicle data can be used to improve simulations by providing more realistic surrounding vehicles in the simulations.

In block 318 operational and/or simulation parameters are adjusted in response to the analysis. The adjustments can result in improved AV operation and/or improved simulation functionality. For example, modeling of other road users in simulations can be updated and/or modified based on data gathered on real world other road users in the specific ODD utilized by the host AV. Thus, simulations can be more accurately tailored to the environment that an AV will experience when operating on the roads and interacting with human-operated vehicles.

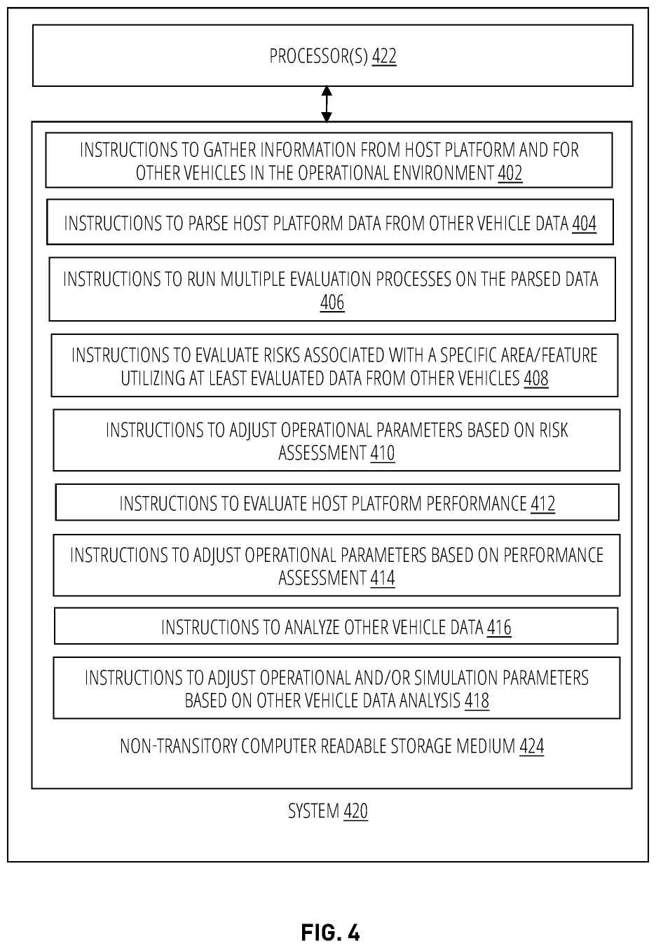

FIG. 4 is a block diagram of one example of processing system 420 that can provide assessment of relative vehicle performance utilizing data gathered by monitoring other vehicles. In one example, system 420 can be part of an autonomous vehicle (e.g., autonomous vehicle 102 as part of internal computing system 124) that utilizes various sensors including RADAR sensors. In other examples, system 420 can be part of a human-operated vehicle having an ADAS that can utilize various sensors including RADAR, LIDAR, and video camera sensors.

In an example, system 420 can include processor(s) 422 and non-transitory computer readable storage medium 424. Non-transitory computer readable storage medium 424 may store instructions 402, 404, 406, 408, 410 and 412 that, when executed by processor(s) 422, cause processor(s) 422 to perform various functions. Examples of processor(s) 422 may include a microcontroller, a microprocessor, a central processing unit (CPU), a graphics processing unit (GPU), a data processing unit (DPU), an application-specific integrated circuit (ASIC), an field programmable gate array (FPGA), a system on a chip (SoC), etc. Examples of a non-transitory computer readable storage medium 424 include tangible media such as random access memory (RAM), read-only memory (ROM), electrically erasable programmable read-only memory (EEPROM), flash memory, a hard disk drive, etc.

Instructions 402 cause processor(s) 422 to gather operational data from the host platform (e.g., autonomous vehicle 102 with sensors 104) for the host platform and observational data is gathered for other vehicles in the operational environment. In one example, the host platform is an AV that is providing rideshare functionality; however, the host platform can be an AV that is not providing a rideshare functionality, such as a human-operated vehicle with an ADAS, etc. Information gathered can be for the host AV platform (e.g., location, speed, acceleration rate, steering angle, proximity to other road users, whether headlights are on). Information can also be gathered for other road users (e.g., speed of other vehicles, following distance of other vehicles, turn signal status). General geographical and/or environmental information can also be gathered (e.g., location, time of day, weather conditions).

Instructions 404 cause processor(s) 422 to parse the data gathered by the host platform. For example, host platform data separated from other vehicle data. As mentioned above, the host platform data and/or the other vehicle data can be run through one or more simulations to provide additional data. Parsing of the data provides multiple data sets that can be utilized for various comparison purposes to provide advantageous analysis, for example, automated ODD management, AV profile management, etc.

Instructions 406 cause processor(s) 422 to perform multiple evaluations on the parsed data sets. For example, safety, comfort and or performance evaluations can be performed on the other vehicle data (e.g., 210). Similarly, safety, comfort and or performance evaluations can be performed on the host platform data (e.g., 226) and safety, comfort and or performance evaluations can be performed on simulation data (e.g., 226). Additional and/or different data set combinations can be generated and additional and/or different evaluations can be performed.

Instructions 408 cause processor(s) 422 to evaluate risks associated with driving in or through a specific traffic feature based on at least the other vehicles using the specific traffic feature. The risk analysis can further utilize data from the host platform. In one example, evaluations of data from the other vehicles and evaluations of data from the host platform can be compared as part of the risk evaluation. Specific traffic features can include, for example, specific intersections, specific sections of a road, construction zones, etc. Any number of characteristics can be utilized to provide specificity to the traffic feature including, for example, time of day, day of the week, season, weather conditions, lighting, etc.

Instructions 410 cause processor(s) 422 to adjust operational parameters of the host platform based on the risk assessment. Adjustment of the operational parameters can include, for example, modification of an AV ODD, modification of routing preferences, limitations on times during which the host platform can access specific traffic features, modification of safety buffers in specified areas, etc.

Instructions 412 cause processor(s) 422 to execute performance evaluations on host platform data and/or other vehicle data. The performance evaluations can be used to, for example, compare AV performance to desired performance levels, compare AV performance to historical AV performance trends, compare AV performance to human-operated vehicles, compare specific AV performance to other AVs in the fleet, etc. Additional and/or different performance evaluations can be supported.

Instructions 414 cause processor(s) 422 to adjust operational parameters based on the performance evaluations. For example, a specific vehicle ODD can be modified based on the performance evaluations and/or an AV fleet OCC can be modified based on individual and/or aggregated performance evaluations. Performance evaluations can also be used to determine areas in which one or more AVs are deficient in performance. This can be based on training of a single AV and/or fleet development. Additional and/or different evaluations and corresponding adjustments can also be supported.

Instructions 416 cause processor(s) 422 to analyze data gathered about other vehicles. In one example, analysis of other vehicle data can be used for comparison purposes to evaluate how well the host AV fits in traffic flows with human-operated vehicles. Results of these comparisons can be utilized to adjust operational parameters for the AV. As another example, analysis of other vehicle data can be used to improve simulations by providing more realistic surrounding vehicles in the simulations.

Instructions 418 cause processor(s) 422 to adjust operational and/or simulation parameters in response to the analysis. The adjustments can result in improved AV operation and/or improved simulation functionality.

In the description above, for the purposes of explanation, numerous specific details are set forth in order to provide a thorough understanding of the described examples. It will be apparent, however, to one skilled in the art that examples may be practiced without some of these specific details. In other instances, well-known structures and devices are shown in block diagram form. There may be intermediate structures between illustrated components. The components described or illustrated herein may have additional inputs or outputs that are not illustrated or described.

Various examples may include various processes. These processes may be performed by hardware components or may be embodied in computer program or machine-executable instructions, which may be used to cause processor or logic circuits programmed with the instructions to perform the processes. Alternatively, the processes may be performed by a combination of hardware and software.

Portions of various examples may be provided as a computer program product, which may include a non-transitory computer-readable medium having stored thereon computer program instructions, which may be used to program a computer (or other electronic devices) for execution by one or more processors to perform a process according to certain examples. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, examples may also be downloaded as a computer program product, wherein the program may be transferred from a remote computer to a requesting computer. In some examples, non-transitory computer readable storage medium 424 has stored thereon data representing sequences of instructions that, when executed by a processor(s) 422, cause the processor(s) 422 to perform certain operations.

Reference in the specification to “an example,” “one example,” “some examples,” or “other examples” means that a particular feature, structure, or characteristic described in connection with the examples is included in at least some examples, but not necessarily all examples. Additionally, such feature, structure, or characteristics described in connection with “an example,” “one example,” “some examples,” or “other examples” should not be construed to be limited or restricted to those example(s), but may be, for example, combined with other examples. The various appearances of “an example,” “one example,” or “some examples” are not necessarily all referring to the same examples.

What is claimed is:

1. A non-transitory computer-readable medium having stored thereon instructions that, when executed by one or more processors, are configurable to cause the one or more processors to:
gather operational information for a host platform and observational information for at least one road user that shares an operating environment with the host platform;
perform one or more evaluations on the operational information for the host platform and on the observational information for the at least one road user; and
evaluate host platform performance based on results from the one or more evaluations on the operational information from the host platform and on results from the observational information from the at least one road user.

2. The non-transitory computer-readable medium of claim 1 further comprising instructions that, when executed, cause the one or more processors to adjust one or more operational parameters of the host platform based on the one or more evaluations.

3. The non-transitory computer-readable medium of claim 1 wherein the one or more evaluations comprise at least evaluating reactivity of the at least one road user based on the observational information for the at least one road user.

4. The non-transitory computer-readable medium of claim 1 wherein the instructions that cause the one or more processors to adjust one or more operational parameters corresponding to the host platform based on the evaluation further comprises instructions that, when executed, cause the one or more processors to adjust operational parameters for multiple autonomous vehicles in a fleet of autonomous vehicles.

5. The non-transitory computer-readable medium of claim 1 wherein the instructions that cause the one or more processors to evaluate host platform performance based on results from the evaluations on the operational information from the host platform and on results from the observational information from the at least one road user further comprise instructions that, when executed by the one or more processors, cause the one or more processors to:
evaluate on-road performance of the host platform to on-road performance of the at least one road user;
compare results of the evaluation to at least one performance threshold;
adjust operational parameters of the host platform based on the comparison; and
cause the one or more processors to identify one or more sequences of operations for which results of the evaluation fall below the performance threshold.

6. The non-transitory computer-readable medium of claim 1 wherein the host platform comprises an autonomous vehicle (AV).

7. The non-transitory computer-readable medium of claim 1 wherein the at least one road user comprises a human-operated vehicle.

8. A system comprising:
a memory system; and
one or more hardware processors coupled with the memory system, the one or more processors configurable to gather operational information for a host platform and observational information for at least one road user that shares an operating environment with the host platform, to perform multiple evaluations on the operational information for the host platform and on the observational information for the at least one road user, to evaluate host platform performance based on results from the evaluations on the operational information from the host platform and on results from the observational information from the at least one road user.

9. The system of claim 8 wherein the one or more hardware processors are further configured to adjust one or more operational parameters corresponding to the host platform based on the evaluation.

10. The system of claim 8 wherein the one or more evaluations comprise at least evaluating reactivity of the at least one road user based on the observational information for the at least one road user.

11. The system of claim 8 wherein adjusting one or more operational parameters corresponding to the host platform based on the evaluation further comprises adjusting operational parameters for multiple autonomous vehicles in a fleet of autonomous vehicles.

12. The system of claim 8 wherein evaluating host platform performance based on results from the evaluations on the operational information from the host platform and on results from the observational information from the at least one road user further comprises causing the one or more hardware processors to:
evaluate on-road performance of the host platform to on-road performance of the at least one platforms;
compare results of the evaluation to at least one performance threshold; and
adjust operational parameters of the host platform based on the comparison.

13. The system of claim 12 comparing results of the evaluation to at least one performance threshold further comprises identifying one or more sequences of operations for which results of the evaluation fall below the performance threshold.

14. The system of claim 8 wherein the host platform comprises an autonomous vehicle (AV) and the at least one road user comprises a human-operated vehicle.

15. The system of claim 8 wherein the host platform comprises a human-operated vehicle with an advanced driver assistance system (ADAS).

16. A method comprising:
gathering operational information for a host platform and observational information for at least one road user that shares an operating environment with the host platform;
performing multiple evaluations on the operational information for the host platform and on the observational information for the at least one road user; and
evaluating host platform performance based on results from the evaluations on the operational information from the host platform and on results from the observational information from the at least one road user.

17. The method of claim 16 further comprising adjusting one or more operational parameters corresponding to the host platform based on the evaluation.

18. The method of claim 16 wherein the one or more evaluations comprise at least evaluating reactivity of the at least one road user based on the observational information for the at least one road user wherein the at least one road user comprises a human-operated vehicle.

19. The method of claim 16 wherein evaluating host platform performance based on results from the evaluations on the operational information from the host platform and on results from the observational information from the at least one road user further comprises:
evaluating on-road performance of the host platform to on-road performance of the at least one platforms;
comparing results of the evaluation to at least one performance threshold; and
adjusting operational parameters of the host platform based on the comparison.

20. The method of claim 16 wherein the host platform comprises an autonomous vehicle (AV).
